(19) United States
(12) Patent Application Publication
(10) Pub. No.: US 2014/0354906 A1
(43) Pub. Date: Dec. 4, 2014

(54) TOUCH PANEL AND METHOD OF ADJUSTING THE SURFACE VISUAL EFFECT OF TOUCH PANEL

(71) Applicant: WINTEK CORPORATION, Taichung City (TW)

(72) Inventors: Yi-Chun Wu, Hualien County (TW); Yu-Chen Liu, Taipei City (TW); Chi-Yuan Hung, New Taipei City (TW)

(73) Assignee: WINTEK CORPORATION, Taichung City (TW)

(21) Appl. No.: 14/290,970

(22) Filed: May 29, 2014

(30) Foreign Application Priority Data
May 30, 2013 (TW) 102119222

(51) Int. Cl. G06F 3/041

(52) U.S. Cl. CPC G06F 3/041
USPC 349/12

(57) ABSTRACT

A touch panel has a touch control region and a peripheral region disposed adjacent to at least one side of the touch control region. The touch panel includes a substrate, a first index matching layer, a decoration layer, and a touch element. The first index matching layer covers a surface of the substrate. The first index matching layer has a first refractive index greater than that of the substrate. The decoration layer is disposed in the peripheral region. The touch element is disposed on the first index matching layer and at least in the touch control region.

### BACKGROUND OF THE INVENTION

1. Field of the Invention

The present invention relates to a touch panel and a method of adjusting the surface visual effect of a touch panel, and more particularly, to a touch panel including an index matching (IM) layer and a method of adjusting the surface visual effect of a touch panel by disposing an index matching layer in the touch panel.

2. Description of the Prior Art

Since touch panels provide human-machine interaction, they have been widely applied to smart phones, global positioning navigator systems (GPS navigator system), tablet personal computers, personal digital assistants (PDA), laptop personal computers, and other electronic devices.

Generally, a touch panel includes a touch control region and a peripheral region. The touch control region has a plurality of touch electrodes disposed therein, and the peripheral region usually includes a decoration layer. There are spacings between adjacent touch electrodes. Although the touch electrodes are made of transparent conductive materials, they still partially reflect light and cause different visual effects between the portion with the touch electrodes and the portion without the touch electrodes (the spacings between adjacent touch electrodes) of the touch panel. Therefore, the user sees the patterns of the touch electrodes on the surface of the touch panel. Additionally, when there is any hole disposed in the decoration layer, even with a shielding film disposed in its back side, the user will still find the existence of the hole due to the different reflection rates of the hole and the decoration layer. The poor visual effect caused by the differences of the reflection rates of the elements of the touch panel mentioned above still requires more researches and developments in the industry to make an improvement.

### SUMMARY OF THE INVENTION

One of the objectives of the present invention is to provide a touch panel that includes at least one layer of the index matching layers to improve the surface visual effect of the touch panel. Another objective of the present invention is to provide a method to improve the surface visual effect of a touch panel by deposing an index matching layer.

To achieve the above-mentioned objectives, the present invention provides a touch panel having a touch control region and a peripheral region disposed adjacent to at least one side of the touch control region. The touch panel includes a substrate, a first index matching layer, a decoration layer and a touch element. The first index matching layer covers a surface of the substrate. The first index matching layer has a first refractive index, and the first refractive index is greater than that of the substrate. The decoration layer is disposed in the peripheral region. The touch element is disposed on the first index matching layer and at least in the touch control region.

To achieve the above-mentioned objectives, the present invention also provides a touch panel having a touch control region and a peripheral region disposed adjacent to at least one side of the touch control region. The touch panel includes a substrate, a touch element and an index matching layer. The substrate has a surface. The touch element comprising a plurality of touch electrodes is disposed on the surface of the substrate and in the touch control region. The index matching layer is disposed on the touch element, fully covering the surface of the substrate, and the refractive index of the index matching layer is different from that of the touch electrodes.

To achieve the above-mentioned objectives, the present invention further provides a method of adjusting the surface visual effect of a touch panel, wherein the touch panel includes a substrate and a patterned component layer disposed on the substrate. The method includes disposing an index matching layer on the upper side or the lower side of the patterned component layer to fully cover the substrate when an intensity of a first reflection light caused by the incident light that penetrates into the patterned component layer through the substrate becomes to produce increases. The index matching layer can produce a second reflection light with a phase retardation opposite to the phase retardation of the first reflection light to reduce the overall intensity of the overall reflection light.

To achieve the above objectives, the present invention even further provides a touch panel having a touch control region and a peripheral region disposed adjacent to at least one side of the touch control region. The touch panel of the present invention includes a substrate, a first index matching layer, a touch element and a decoration layer, wherein the substrate has a surface. The first index matching layer is disposed on the surface of the substrate and includes a first refractive index, and the first refractive index is greater than a refractive index of the substrate. The touch element is disclosed at least in the touch control region, and the decoration layer is disposed in the peripheral region and on the first index matching layer.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of the partial cross-section view of a touch panel according to the first embodiment of the present invention.

FIG. 2 is a schematic diagram of the top view of the touch panel shown in FIG. 1 according to the first embodiment of the present invention.

FIG. 3 is a curve chart of the reflection rates in the decoration layer region of a touch panel according to the first embodiment of the present invention and a traditional touch panel.

FIG. 4 is a schematic diagram of the partial cross-section view of a touch panel according to the second embodiment of the present invention.

FIG. 5 is a comparison chart of the reflection rate between the touch panel of the second embodiment of the present invention and a traditional touch panel.

FIG. 6 is a schematic diagram of the partial cross-section view of a touch panel according to the third embodiment of the present invention.

FIG. 7A is a schematic diagram of the partial cross-section view of a touch panel according to the fourth embodiment of the present invention.

FIG. 7B is a schematic diagram of the partial cross-section view of a touch panel according to a variant embodiment of the fourth embodiment of the present invention.

FIG. 8 is a schematic diagram of the partial cross-section view of a touch panel according to the fifth embodiment of the present invention.

FIG. 9 is a schematic diagram of the partial cross-section view of a touch panel according to the sixth embodiment of the present invention.

### DETAILED DESCRIPTION

To provide a better understanding of the present invention to the skilled users in the technology of the present invention, preferred embodiments will be detailed as follows. The preferred embodiments of the present invention are illustrated in the accompanying drawings with numbered elements to elaborate on the contents and effects to be achieved.

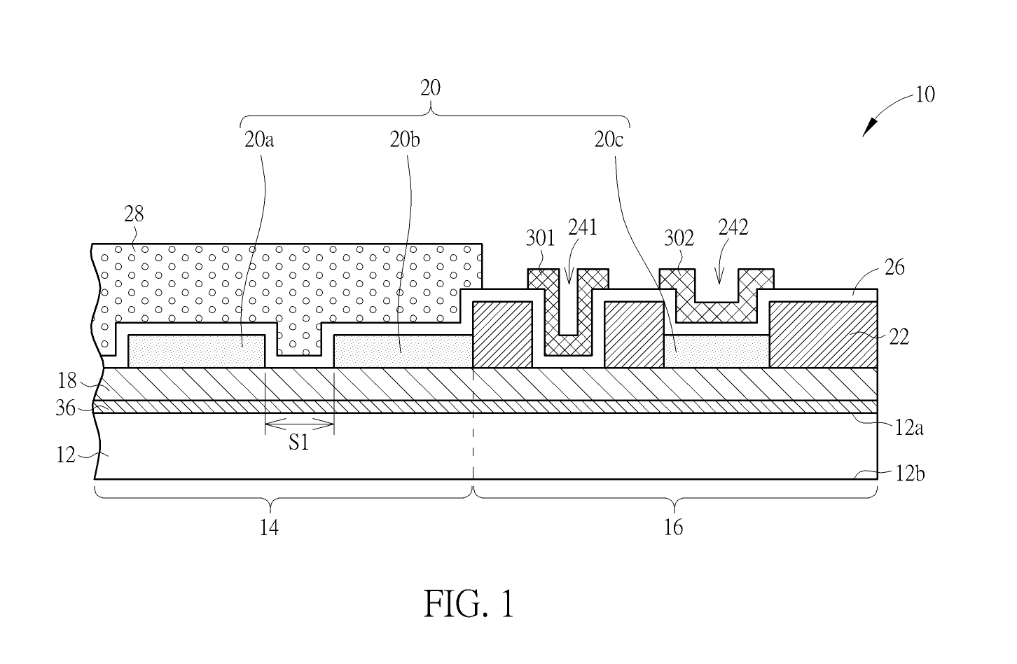

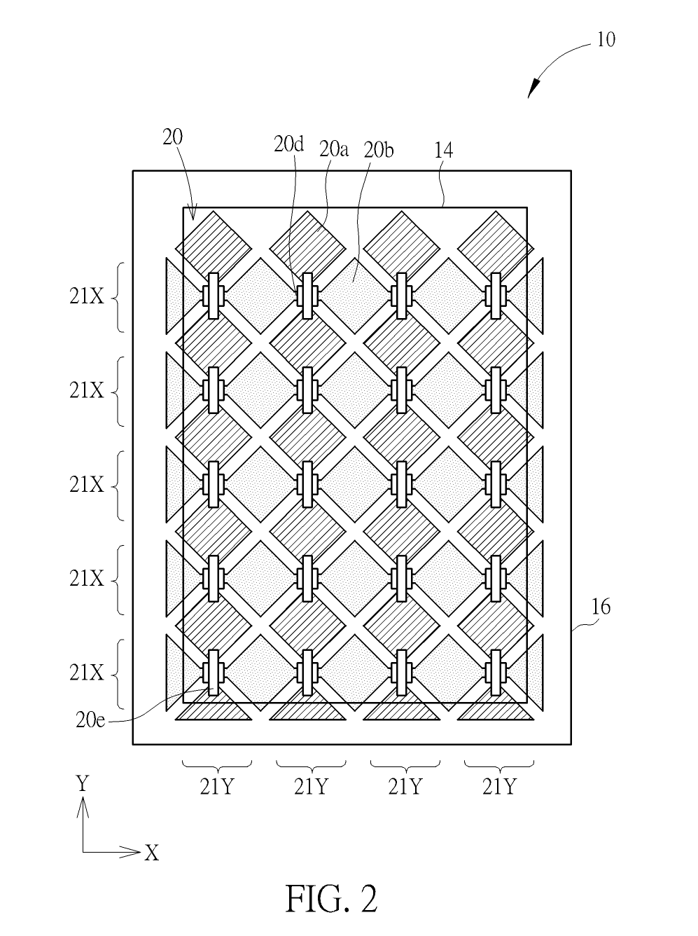

Referring to FIG. 1 and FIG. 2, FIG. 1 is a schematic diagram of the partial cross-section view of a touch panel according to the first embodiment of the present invention, and FIG. 2 is a schematic diagram of the top view of the touch panel shown in FIG. 1. The touch panel 10 according to the first embodiment of the present invention includes a touch control region 14 and a peripheral region 16. The peripheral region 16 is disposed adjacent to at least one side of the touch control region 14. In this embodiment, the peripheral region 16 surrounds the touch control region 14, but it is not limited thereto. The peripheral region 16 may be only adjacent to a portion of the edges of the touch control region 14 as needed. The touch panel 10 includes a substrate 12, a first index matching layer 18, a decoration layer 22 and a touch element 20. The substrate 12 has a first surface 12a and a second surface 12b, disposed opposite to each other, wherein the second surface 12b is the touch control surface for the users to operate the touch panel 10. The first index matching layer 18 fully covers the first surface 12a of the substrate 12, and is disposed in both the peripheral region 16 and the touch control region 14. However, in other embodiments, the first index matching layer 18 may cover only most part of the first surface 12a, or be only disposed in the region of the first surface 12a having the decoration layer 22 to be positioned between the decoration layer 22 and substrate 12. The material included by the first index matching layer 18 has a first refractive index. The first refractive index is greater than that of the substrate 12, or the first refractive index is at least slightly greater than that of the substrate 12. The decoration layer 22 is disposed on the first index matching layer 18 and in the peripheral region 16. In this embodiment, the touch panel 10 further includes at least one hole disposed in the decoration layer 22, exposing the first index matching layer 18. For example, the decoration layer 22 in FIG. 1 includes the holes 241 and 242, and they may serve as an infrared ray (IR) sensing hole (hereinafter referred to as “IR hole”) and a button hole respectively. When the hole 241 is used as the IR hole, an IR sensor can be disposed on the upper side of the hole 241 in order to sense the usage of the touch panel. The touch element 20 is disposed on the first index matching layer 18 and in the touch control region 14, but not limited to thereto. The touch element 20 may also extend to the peripheral region 16 as needed, such as directly disposing respectively setting a touch electrode 20c in the region or around the region of the hole 242 which is used as the button hole so that the hole 242 exposes the touch electrode 20c and the first index matching layer 10 underneath it. As an example, the touch element 20 includes a plurality of first axial electrodes 21X and a plurality of second axial electrodes 21Y disposed in the touch control region 14 by a way of being isolated from each other and intersecting each other. The first axial electrodes 21X and the second axial electrodes 21Y extend separately along different directions. For example, the first axial electrodes 21Y and the second axial electrodes 21Y extend along the X direction and Y direction in the figure respectively and are perpendicular to each other. Each of the first axial electrodes 21X and the second axial electrodes 21Y respectively includes a plurality of touch electrodes to be electrically connected in series. FIG. 1 shows only two touch electrodes 20a, 20b as an illustration. The touch electrodes 20a, 20b are uniformly distributed in the touch control region 14, and the touch electrodes 20b in the first axial electrodes 21X and the touch electrodes 20a in the second axial electrodes 21Y are connected in series respectively by the wires 20d and wires 20e to effect the desired of touch-control detection. The shapes of the touch electrodes 20a, 20b can be designed as required. They may be, for example, diamond electrodes or triangle electrodes, but not be limited thereto. The touch element 20 includes transparent conductive materials, such as indium tin oxide (ITO). In other embodiments, the touch electrodes 20a, 20b included in the touch element 20 may also be a plurality of triangle touch electrodes disposed reversely side by side or a plurality of rectangular touch electrodes disposed separately from each other. However, the present invention is not limited to the above description. Touch electrodes with other regular or irregular shapes can be used as needed and distributed uniformly in the touch control region 14, such as a plurality of strip touch electrodes with a plurality of pad touch electrodes disposed between two adjacent strip touch electrodes to effect the desired touch-control detection. The touch panel 10 further includes a protection layer 26 disposed on the upper side of the touch element 20, covering the touch electrodes 20a, 20b, 20c, the decoration layer 22 and a portion of the first index matching layer 18 to provide protection for the touch electrodes 20a, 20b, 20c. The material of the protection layer 26 for example may be silicon dioxide or organic polymer, but not limited thereto. On top of the protection layer 26, an optical clear adhesive (OCA) 28 and one or more ink layer(s) (such as the ink layers 301, 302) can be disposed. As an example, the ink layer 301 may include ink materials only allowing light with certain wavelength (IR light, for example) to pass through, such as IR ink, and is disposed in and around the hole 241 used as an IR hole. The ink layer 302 may be a semitransparent ink layer and disposed correspondingly to the hole 242 regarded as the buttonhole and other small holes which require concealment, but not limited thereto.

As shown in FIG. 1, a spacing s1 exists between the touch electrodes 20a and 20b, thus the spacing S1, the holes 241 and 242, the patterned touch element 20, and the decoration layer 22 have different reflection rates due to their different materials when incident light penetrates from the touch control surface, namely the second surface 12b of the substrate 12. And it is the purpose of disposing the first index matching layer 18 for compensating the differences of the reflection rate or adjusting the color of the decoration layer, in order to improve the visual effect appearing on the touch control surface (the second surface 12b) of the touch panel 10. The above-mentioned method is carried out by selecting the refractive index of the first index matching layer 18 to be at least slightly greater than the refractive index of the substrate 12 to achieve optical index matching. For example, if the substrate 12 is a glass substrate and its refractive index is about 1.5, the first refractive index, defined as the refractive index of the first index matching layer 18, preferably has a range from about 1.55 to about 2.5, more preferably from about 1.65 to about 1.9. Therefore, the material of the first index matching layer 18 can include at least one of titanium oxide (TiO₂), niobium oxide (NbOₓ), aluminum oxide (Al₂O₃), silicon nitride (SiNx), and silicon oxide (SiOx). In addition, the thickness of the first index matching layer 18 is about 50 angstroms to 1000 angstroms, or about 100 angstroms to 400 angstroms. However, the material and refractive index of the substrate 12 and the materials, the refractive index and the thickness of the first index matching layer 18 are examples only and they should not be used for limiting the field of the present invention. In addition, a strengthening layer 36 can also be provided between the substrate 12 and the first refractive index 18 for improving the ability of impact resistance of the substrate 12 and protecting the touch element 20. The material of the strengthening layer 36 may include transparent organic material, such as polyurethane (PU) group, polyimide (PI) group, epoxy resin group, phenol formaldehyde (PF) resin group, polyester group, silicon-containing rubber (such as polyisoprene rubber), silicon-containing material, rubber material, or composite organic material of the above-mentioned materials. In addition, the strengthening layer 36 may have a composite material of organic material and inorganic material, such as a composite material including acrylic group material as the host doped with silica or Al₂O₃ particles, wherein the mix of organic material and inorganic material may be performed through chemical bonding or without chemical bonding. For example, the strengthening layer 36 may include positive photoresist or negative photoresist including thermosetting resin or light curing resin. The strengthening layer 36 may also be composed of inorganic material, such as SiO₂, SiNx, TiO₂ or SiOxNy.

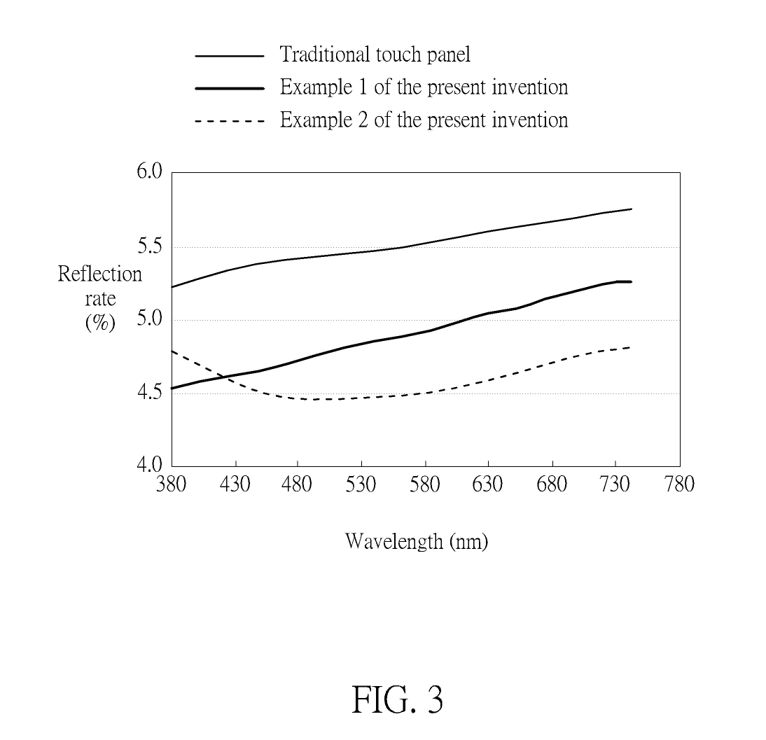

Referring to FIG. 3, FIG. 3 is a curve chart of the reflection rates in the decoration layer region of a touch panel according to the first embodiment of the present invention and a traditional touch panel, wherein the horizontal axis indicates the wavelength of the incident light and the vertical axis indicates the reflection rate. The higher the reflection rate is, the more clearly the holes 241 and 242 show, or the greater the difference between the reflection rates of the holes 241 and 242 and the reflection rate of the decoration layer 22 is. On the contrary, the lower the reflection rate is, the less clearly the holess 241 and 242 show and the better the visual effect is. The traditional touch panel shown in FIG. 3 has holes in its decoration layer in the peripheral region but does not have the first index matching layer of the present invention. Example 1 and example 2 of the present invention are demonstrated separately by using the structure of the touch panel 10 shown in FIG. 1, wherein the first index matching layer in Example 1 of the present invention has a thickness of 96 angstroms and a refractive index of 1.8, and the first index matching layer of in Example 2 of the present invention has a thickness of 300 angstroms and a refractive index of 1.71. According to FIG. 3, incident lights with different wavelengths are provided. The local reflection rate of the decoration layer 22 of the traditional touch panel without the first index matching layer is from about 5.2% to about 5.7%, the local reflection rate of the decoration layer 22 of Example 1 of the present invention is from about 4.5% to about 5.2%, and the local reflection rate of the decoration layer 22 of Example 2 of the present invention is from about 4.4% to about 4.8%. As a result, comparing to the traditional touch panel, no matter what wavelength of the incident light is, the reflection rate around the hole region of the touch panel of the present invention is less than that of the traditional touch panel because the touch panel of the present invention has the first index matching layer, which means that the difference between the reflection rate of the hole region and the decoration layer of the touch panel of the present invention is less than that of the traditional touch panel and a better visual effect is provided by the present invention.

The touch panel of the present invention is not limited by the aforementioned embodiment, and may have other different preferred embodiments and variant embodiments. To simplify the description, the identical components in each of the following embodiments and variant embodiments are marked with identical symbols. For making it easier to compare the difference between the embodiments and variant embodiments, the following description will detail the dissimilarities among different embodiments and variant embodiments and the identical features will not be redundantly described.

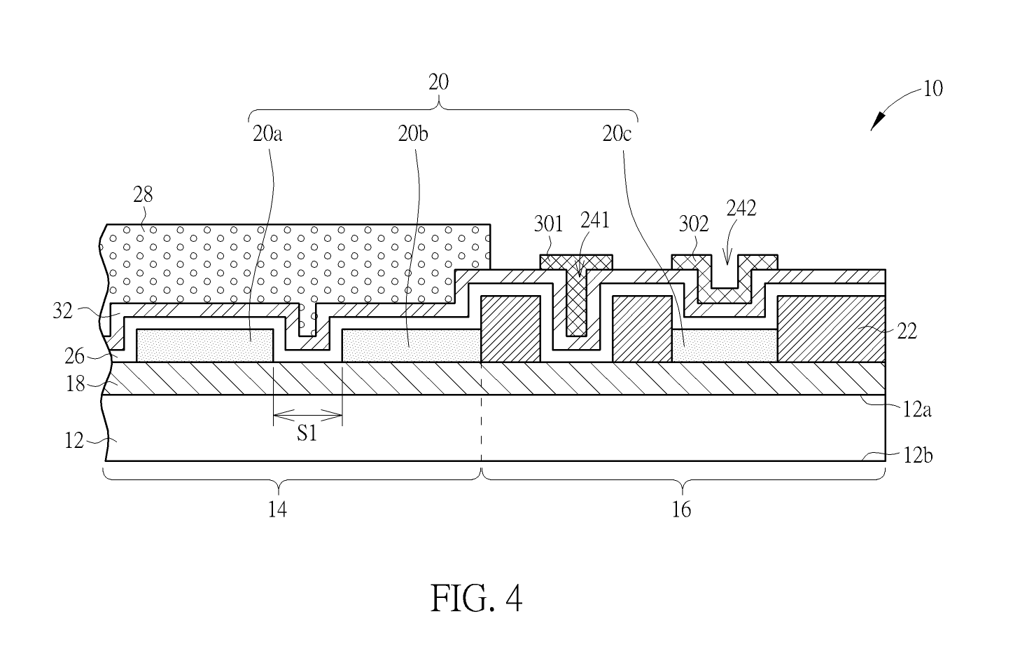

Referring to FIG. 4, FIG. 4 is a schematic diagram of the partial cross-section view of a touch panel according to the second embodiment of the present invention. The difference between this embodiment and the first embodiment is that the touch panel 10 in this embodiment further includes a second index matching layer 32 disposed on the first index matching layer 18, the touch element 20 and the protection layer 26. The second index matching layer 32 covers the surface of the touch element 20 and has a second refractive index, wherein the second refractive index is different from the refractive index of the protection layer 26, which means that the second refractive index is greater than or less than that of the protection layer 26. For example, if the material of the protection layer 26 is silicon dioxide and its refractive index is about 1.5, the second refractive index should be greater than 1.5 or less than 1.5, such as greater than about 1.5 and less than or equal to about 2.2. In a preferred embodiment, the range of the second refractive index is from about 1.6 to about 2.0, but not limited thereto. In addition, the second refractive index of the second index matching layer 32 is preferably different from the refractive index of the touch electrodes 20a, 20b, 20c. The materials of the second index matching layer 32 can be referred to the materials of the first index matching layer 18 in the first embodiment, but should not be limited thereto. All materials meet the above requirements and have transparent effect may be used. In this embodiment, the thickness of the protection layer 26 is about 200 angstroms to 700 angstroms, and the thickness of the second index matching layer 32 is about 100 angstroms to about 2000 angstroms, but not limited thereto. In addition, a strengthening layer (not shown in FIG. 4) can also be provided between the substrate 12 and the first refractive index 18 for improving the ability of impact resistance of the substrate 12 and protecting the touch element 20.

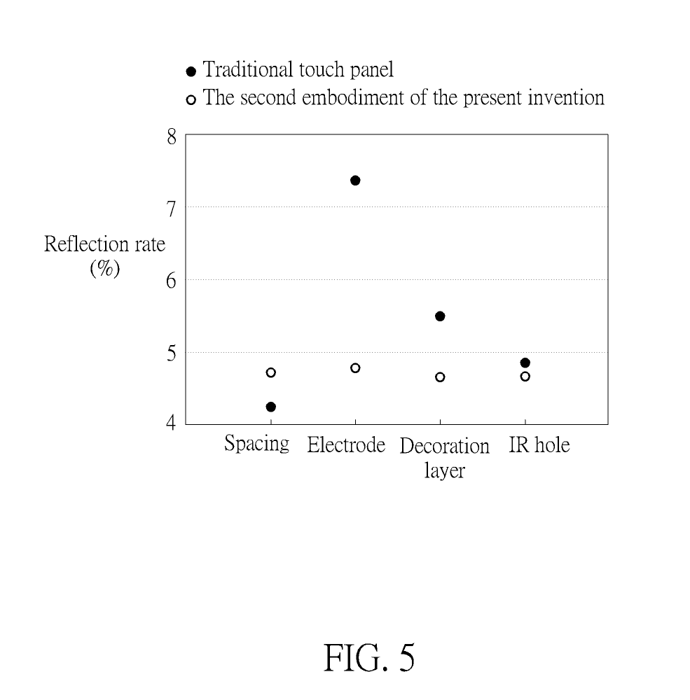

Referring to FIG. 5, FIG. 5 is a comparison chart of the reflection rate between the touch panel of the second embodiment of the present invention and a traditional touch panel. According to FIG. 5, the reflection rated of the spacing, the touch electrodes, the decoration layer, and the hole such as an IR hole of the traditional touch panel are about 4.2%, 7.35%, 5.4% and 4.8% respectively. Because the differences among the four reflection rates are great, it is easy to see the patterns of the above four portions such that the visual effect is affected. On the other hand, the reflection rates of the spacing S1, the touch electrodes 20a and 20b, the decoration layer 22, and the hole 241 such as an IR hole of the touch panel 10 according to the second embodiment of the present invention are about 4.75%, 4.8%, 4.65% and 4.65% respectively. Wherein, because the hole 241 serving as the button hole has a touch electrode 20c disposed therein, its reflection rate is the same as that of the touch electrodes 20a and 20b. If the other holes of the touch panel 10 do not have touch electrodes, their reflection rate will be the same as that of the IR hole. As a result, all the reflection rates in the second embodiment of the present invention are within the range of 4.7%±0.1, and the differences of the reflection rates are obviously lower than those of the traditional touch panel. Therefore, the visual effect of the touch panel 10 can be improved effectively and it will not be easy for the user to see the pattern of every element of the touch panel 10 from the touch control surface (the second surface 12b).

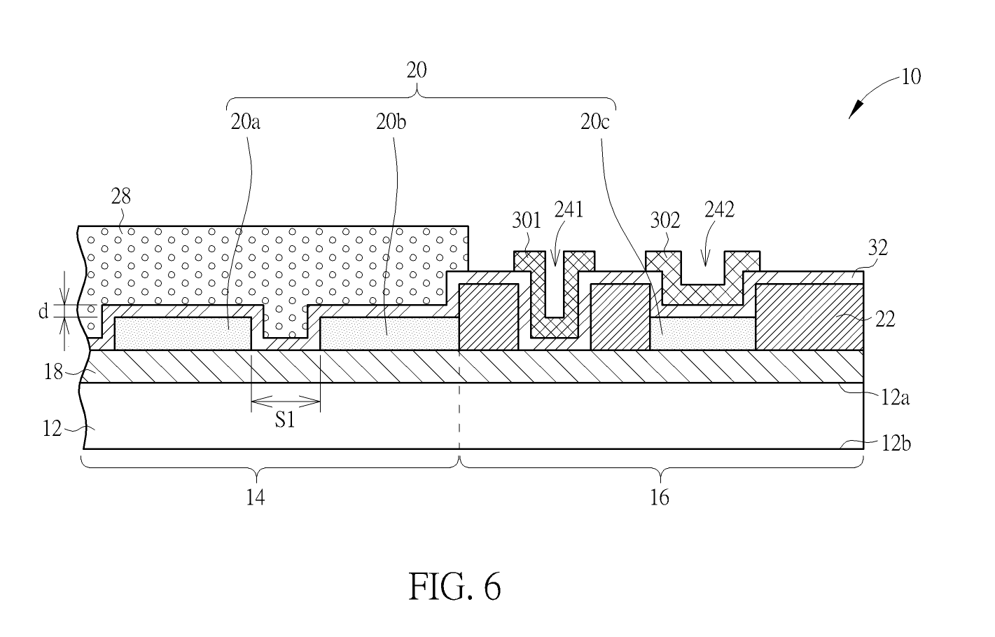

Referring to FIG. 6, FIG. 6 is a schematic diagram of the partial cross-section view of a touch panel according to the third embodiment of the present invention. The difference between this embodiment and the second embodiment is that no protection layer is disposed on the surface of the touch element 20 in the touch panel 10 of this embodiment. In this situation, the second index matching layer 32 directly covers the touch element 20 and directly contacts the surfaces of the touch electrodes 20a, 20b, 20c. The second index matching layer 32 has a second refractive index which is different from the refractive index of the touch electrodes 20a, 20b, 20c. For example, when the refractive index of the touch electrodes 20a, 20b, 20c is about 1.9, the second refractive index should be greater than or less than 1.9 such that the reflection light produced when an incident light penetrates into the second index matching layer 32 from the touch element 20 can offset the reflection light of the touch element 20. In addition, a strengthening layer (not shown in FIG. 6) can also be provided between the substrate 12 and the first refractive index 18 for improving the ability of impact resistance of the substrate 12 and protecting the touch element 20.

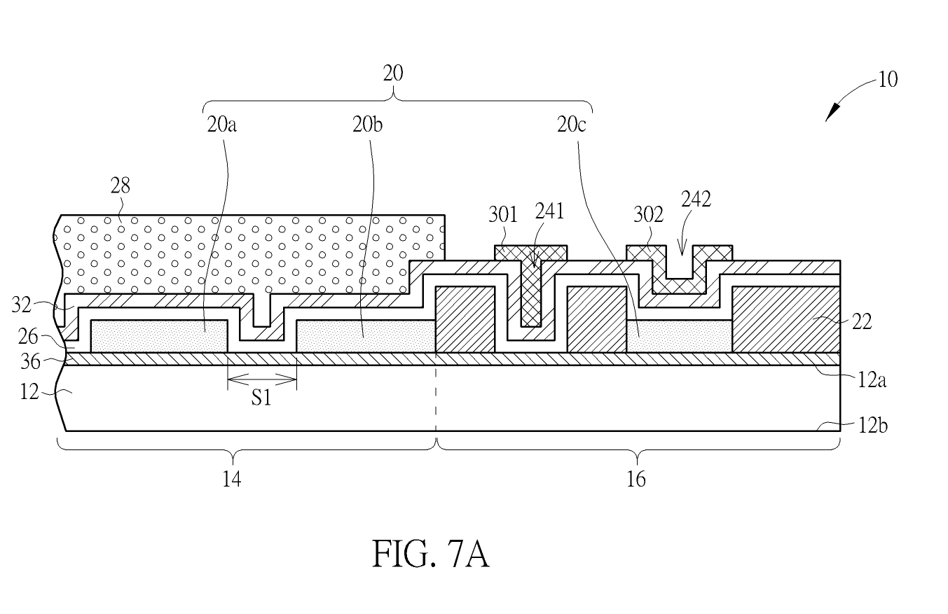

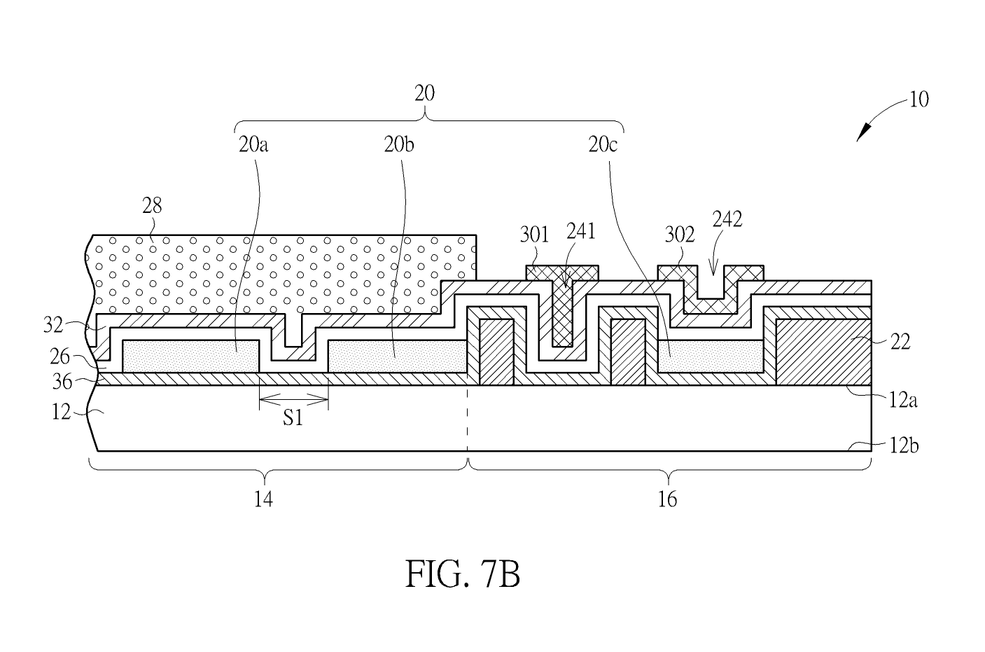

Referring to FIG. 7A, FIG. 7A is a schematic diagram of the partial cross-section view of a touch panel according to the fourth embodiment of the present invention. Comparing to the second embodiment of the present invention shown in FIG. 4, the touch panel 10 according to the fourth embodiment of the present invention does not include the first index matching layer 18. On the touch element 20, the protection layer 26 and the second index matching layer 32 are disposed in order from bottom to top in this embodiment, wherein the disposition requirements of the protection layer 26 and the second index matching layer 32 such as materials, thickness, and refractive index can be referred to the second embodiment. According to this embodiment, the disposition of the protection layer 26 and the second index matching layer 32 can improves the visual effect of the touch element 20, so as to prevent the user from seeing the patterns of each element of the touch element 20, such as the touch electrodes 20a, 20b, from the touch control surface (namely the second surface 12b). In addition, a strengthening layer 36 can also be provided between the substrate 12 and the touch element 20 for improving the ability of impact resistance of the substrate 12 and protecting the touch element 20. With reference to FIG. 7B, the difference between FIG. 7B and FIG. 7A is that the decoration layer 22 is formed on the substrate 12 first in this variant embodiment in FIG. 7B. Therefore, the strengthening 36 in the peripheral region 16 is disposed on the decoration layer 22.

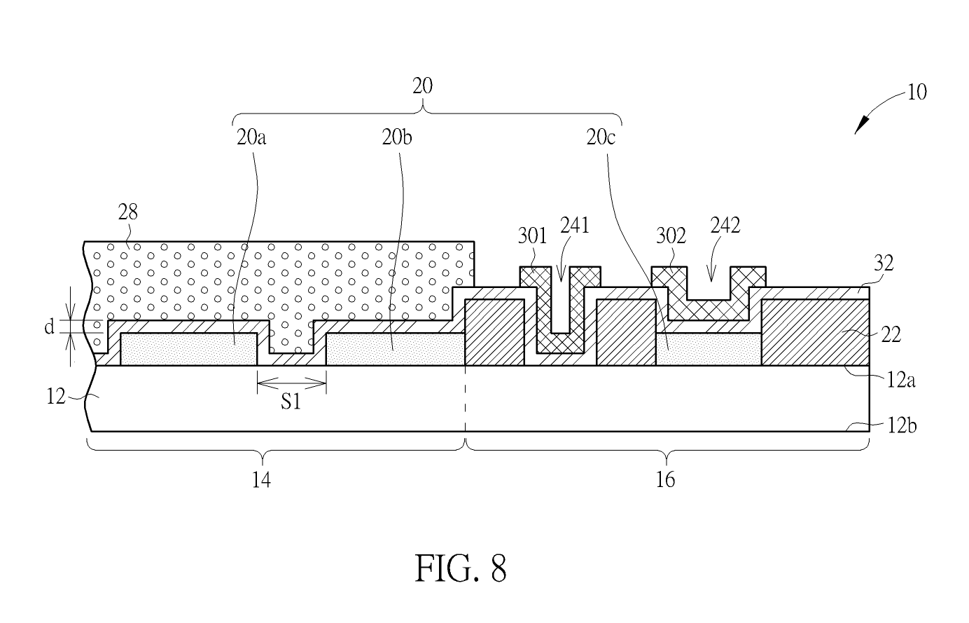

Referring to FIG. 8, FIG. 8 is a schematic diagram of the partial cross-section view of a touch panel according to the fifth embodiment of the present invention. Comparing to the third embodiment of the present invention shown in FIG. 6, the touch panel 10 according to the fifth embodiment of the present invention does not have the first index matching layer 18, and only a layer of the second index matching layer 32 is disposed on the touch element 20, wherein the requirements of the second index matching layer 32, such as materials, thickness, and refractive index can be referred to the second and the third embodiments. This embodiment uses the disposition of the second index matching layer 32 to also improve the visual effect of the touch element 20. In addition, a strengthening layer (not shown in FIG. 8) can also be provided between the substrate 12 and the touch element 20 for improving the ability of impact resistance of the substrate 12 and protecting the touch element 20.

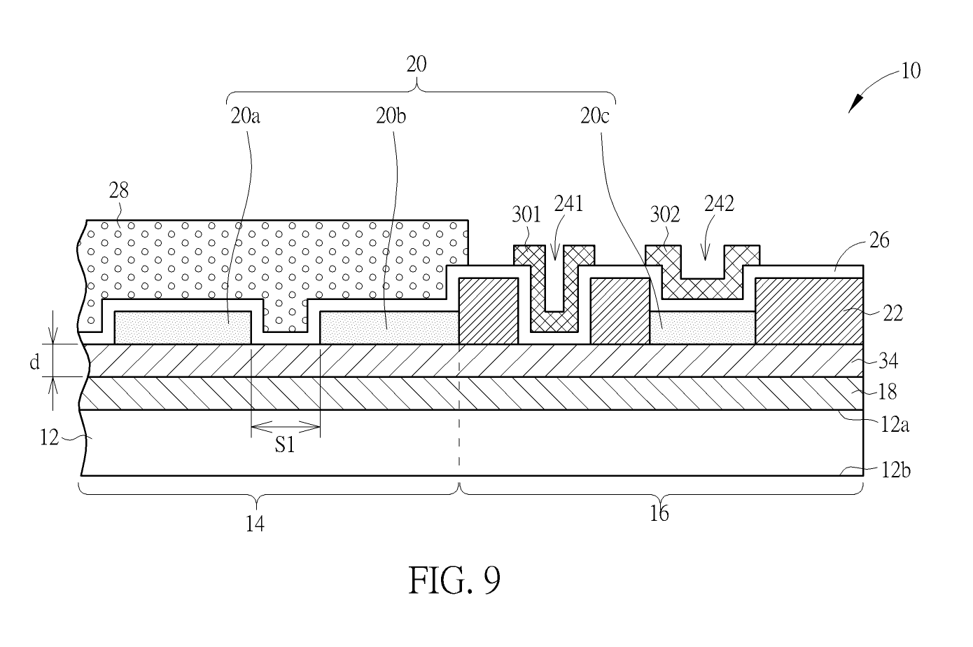

Referring to FIG. 9, FIG. 9 is a schematic diagram of the partial cross-section view of a touch panel according to the sixth embodiment of the present invention. Comparing to the second embodiment of the present invention shown in FIG. 4, the touch panel 10 according to the sixth embodiment of the present invention does not have the second index matching layer 32 disposed on the protection layer 26, but a second index matching layer 34 is disposed between the first index matching layer 18 and the touch element 20, as well as the decoration layer 22. In this embodiment, the second index matching layer 34 has a second refractive index. The second refractive index is preferably less than the first refractive index of the first index matching layer 18, and it is more preferably different from the refractive index of the touch electrodes 20a, 20b, 20c. By doing so, the reflection light caused by the incident light penetrating into the second index matching layer 34 will offset the reflection light caused by the light penetrating into the touch element 20, so as to reduce the overall reflection rate of the touch element 20 of the touch panel 10. In other embodiments, the second index matching layer 34 may cover the surface of the decoration layer 22 alternatively, which means the decoration layer 22 is formed before the second index matching layer 34, but it is not limited thereto. In addition, a strengthening layer (not shown in FIG. 9) can also be provided between the substrate 12 and the first refractive index 18 for improving the ability of impact resistance of the substrate 12 and protecting the touch element 20.

According to the above, the present invention uses the index matching layer disposed on the upper side or the lower side of the film layer with special patterns or with higher reflection rate (such as a touch element), whose refractive index is different from the aforementioned film layer, so as to offset the reflection lights from both layers to reduce the overall reflection rate and furthermore to improve the surface visual effect of the touch panel. For example, taking the touch element 20 in the previous embodiments as a patterned component layer with patterns, if the reflection light (hereinafter called as the first reflection light) caused by the light penetrating into the touch element 20 becomes stronger due to the phase retardation of the touch element 20, the condition of the disposition of the index matching layer is to make the reflection light (hereinafter called as the second reflection light) of the index matching layer has an opposite phase to the phase of the reflection light of the touch element 20 and make the second reflection light caused by the light penetrating into the index matching layer to produce destructive interference to offset the first reflection light of the touch element 20.

As a result, with the third embodiment of the present invention shown in FIG. 6 as an example, the present invention provides a method of adjusting the surface visual effect of the touch panel 10. The touch panel 10 includes a substrate 12 and a patterned component layer disposed on the first surface 12a of the substrate 12. The patterned component layer for example may be the touch element 20 including the touch electrodes 20a, 20b, and 20c, but not limited thereto. The patterned component layer can also be referred to the decoration layer 22, the wire layer or other film layer with patterns and higher reflection rate. The aforementioned method of the present invention includes: when the first reflection light caused by the light passing through the substrate 12 and penetrating into the touch element 20 produces constructive interference, disposing an index matching layer comprehensively on the upper side or the lower side of the touch element 20 to cover the substrate 12 to make the second reflection light caused by the light penetrating into the index matching layer to produce destructive interference. For example, the second index matching layer 32 is disposed on the upper side of the touch element 20 in FIG. 6, while the second index matching layer 34 is disposed on the lower side of the touch element 20 in FIG. 9. Wherein in the preferred embodiments, the refractive index of the second index matching layer 32 or 34 should be different from that of the touch electrodes 20a, 20b, 20c. The second index matching layer 32 or 34 and the touch electrodes 20a, 20b, 20c have a refractive index difference Δn, and the thickness of the second index matching layer 32 or 34 is d. The method to produce destructive interference is to make the product of the refractive index difference “Δn” and the thickness “d” of the second index matching layer 32 or 34 about equal to one fourth of the wavelength “λ” of the incident light, which means to fulfill the formula Δn×d=λ/4.

According to the present invention, when the touch panel includes a patterned component layer with higher reflection rate or higher refractive index, such as a touch element or a decoration layer, one or two layers of index matching layers can be disposed on most or all surface of the substrate of the touch panel, using the refractive index difference of the index matching layer and the patterned component layer to make the reflection lights of both be offset and canceled out and reduce the difference among reflection rates of any portions of the touch panel. As a result, the reflection rate of each patterned component layer is similar to each other and the visual difference can be decreased, so as to improve the surface visual effect of the touch panel. Even though the film layer of the touch element or other patterned component layer is thicker in a touch panel with bigger size, the index matching layer of the present invention still can effectively decrease the reflection rate of the patterned component layer and adjust the difference of the reflation rates of different layers. Similarly, by disposing an index matching layer with greater refractive index than that of the substrate on the surface of the substrate can also reduce the visual difference between the portion of the substrate with the patterned component layer and the portion without the patterned component layer, such as reducing the visual difference between the decoration layer and the IR hole. As a result, the surface visual effect of the touch panel will be improved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A touch panel, having a touch control region and a peripheral region disposed adjacent to at least one side of the touch control region, the touch panel comprising:
a substrate, having a surface;
a first index matching (IM) layer, covering the surface of the substrate, the first index matching layer having a first refractive index greater than a refractive index of the substrate;
a decoration layer, disposed in the peripheral region; and
a touch element, disposed on the first index matching layer and at least in the touch control region.

2. The touch panel of claim 1, wherein the first index matching layer is disposed in the peripheral region and the touch control region.

3. The touch panel of claim 2, wherein the decoration layer is disposed on the first index matching layer.

4. The touch panel of claim 3, wherein the decoration layer includes at least one hole, exposing the first index matching layer.

5. The touch panel of claim 4, further comprising an ink layer, the ink layer being disposed correspondingly to the hole.

6. The touch panel of claim 3, wherein the decoration layer includes at least one hole, exposing the first index matching layer and the touch element.

7. The touch panel of claim 6, further comprising an ink layer, the ink layer being disposed correspondingly to the hole.

8. The touch panel of claim 3, further comprising a second index matching layer disposed between the first index matching layer and the decoration layer.

9. The touch panel of claim 8, wherein the second index matching layer has a second refractive index less than the first refractive index.

10. The touch panel of claim 1, wherein a range of the first refractive index is from about 1.55 to about 2.5.

11. The touch panel of claim 10, wherein the range of the first refractive index is from about 1.65 to about 1.9.

12. The touch panel of claim 1, wherein a material of the first index matching layer comprises at least one of the following: titanium oxide (TiO₂), niobium oxide (NbOₓ), aluminum oxide (Al₂O₃), silicon nitride (SiNx), and silicon oxide (SiOx), and the substrate is a glass substrate.

13. The touch panel of claim 1, wherein a thickness of the first index matching layer is about 50 angstroms to 1000 angstroms.

14. The touch panel of claim 13, wherein the thickness of the first index matching layer is about 100 angstroms to 400 angstroms.

15. The touch panel of claim 1, further comprising a second index matching layer covering the touch element, the touch element comprising a plurality of touch electrodes, and the second index matching layer having a second refractive index different from a refractive index of the touch electrodes.

16. The touch panel of claim 15, further comprising a strengthening layer sandwiched between the substrate and the first index matching layer.

17. The touch panel of claim 16, further comprising a protection layer disposed between the second index matching layer and the touch element, and the second refractive index different from a refractive index of the protection layer.

18. The touch panel of claim 17, wherein the second refractive index is less than the refractive index of the protection layer.

19. The touch panel of claim 17, wherein the second refractive index is greater than the refractive index of the protection layer.

20. The touch panel of claim 19, wherein a material of the protection layer comprises silica, and the range of the second refractive index is greater than about 1.5 and less than or equal to about 2.2.

21. The touch panel of claim 17, wherein a thickness of the protection layer is about 200 angstroms to about 700 angstroms, and a thickness of the second index matching layer is about 100 angstroms to about 2000 angstroms.

22. The touch panel of claim 1, further comprising a second index matching layer disposed between the first index matching layer and the touch element.

23. The touch panel of claim 22, further comprising a strengthening layer sandwiched between the substrate and the first index matching layer.

24. The touch panel of claim 23, wherein the second index matching layer has a second refractive index less than the first refractive index.

25. The touch panel of claim 1, further comprising an optical clear adhesive (OCA) disposed on the touch element.

26. The touch panel of claim 1, further comprising a strengthening layer sandwiched between the substrate and the first index matching layer.

27. A touch panel, having a touch control region and a peripheral region adjacent to at least one side of the touch control region, the touch panel comprising:
a substrate, having a surface;
a touch element, disposed on the surface of the substrate and at least in the touch control region, and the touch element comprising a plurality of touch electrodes; and
an index matching layer disposed on the touch element, a refractive index of the index matching layer being different from a refractive index of the touch electrodes.

28. The touch panel of claim 27, further comprising a protection layer disposed between the index matching layer and the touch element, and the refractive index of the index matching layer being different from a refractive index of the protection layer.

29. The touch panel of claim 28, wherein the refractive index of the index matching layer is less than a refractive index of the protection layer.

30. The touch panel of claim 28, wherein the refractive index of the index matching layer is greater than a refractive index of the protection layer.

31. The touch panel of claim 30, wherein a material of the protection layer comprises silica, and a range of the refractive index of the index matching layer is from about 1.5 to about 2.2.

32. The touch panel of claim 28, wherein a thickness of the protection layer is about 200 angstroms to about 700 angstroms, and a thickness of the index matching layer is about 100 angstroms to about 200 angstroms.

33. The touch panel of claim 27, further comprising a solid optical clear adhesive and an ink layer disposed on the index matching layer.

34. The touch panel of claim 27, further comprising a strengthening layer sandwiched between the substrate and the touch element.

35. A method of adjusting a surface visual effect of a touch panel, wherein the touch panel has a substrate and a patterned component layer disposed on the substrate, the method comprising that when a first reflection light that is penetrating caused by an incident light penetrating into the patterned component layer through the substrate becomes more intensive, comprehensively disposing an index matching layer on an upper side or a lower side of the patterned component layer to cover the substrate, the index matching layer being capable of producing a second reflection light whose phase retardation is opposite to a phase retardation of the first reflection light so as to reduce overall intensity of reflection light.

36. The method of adjusting the surface visual effect of the touch panel of claim 35, wherein a refractive index of the index matching layer and a refractive index of the patterned component layer have a refractive index difference, and a method to form a destructive interference comprises providing a condition of that the product of the refractive index difference and a thickness of the index matching layer is about equal to one fourth of wavelength of the incident light.

37. A touch panel, having a touch control region and a peripheral region disposed adjacent to at least one side of the touch control region, the touch panel comprising:
a substrate, having a surface;
a first index matching (IM) layer, disposed on a surface of the substrate, the index matching layer having a first refractive index greater than a refractive index of the substrate;
a touch element, at least disposed in the touch control region; and
a decoration layer, disposed in the peripheral region and on the first index matching layer.

38. The touch panel of claim 37, further comprising a second index matching layer disposed between the first index matching layer and the decoration layer, the second index matching layer having a second refractive index lower than the first refractive index.
